(19) United States
(12) Patent Application Publication
(10) Pub. No.: US 2018/0006528 A1
(43) Pub. Date: Jan. 4, 2018

(54) RACK FOR GENERATING ELECTRICAL POWER

(71) Applicant: Reginald William BREWSTER, Ontario (CA)

(72) Inventor: Reginald William BREWSTER, Ontario (CA)

(21) Appl. No.: 15/640,628

(22) Filed: Jul. 3, 2017

(30) Foreign Application Priority Data
Jul. 4, 2016 (CA) 2 935 115

(51) Int. Cl. H02K 7/18; H02J 7/14

(52) U.S. Cl. CPC H02K 7/1861; H02J 7/1423

(57) ABSTRACT

A power generating rack includes a frame; a number of parallel spaced apart rollers; and a generator in communication with the rollers for converting the energy of rotation of the rollers into electrical energy. The frame supports a vehicle such as a car, truck and bicycle in such a way that the driving wheel of the vehicle is positioned between a pair of rollers and as the driving wheel rotates so too do the rollers which energizes the generator.

### FIELD OF THE INVENTION

This invention relates to apparatus for generating electrical power and more particularly to a rack which functions to produce electrical power and which is activated by devices which are designed for purposes other than the generation of electrical power such as bicycles, motorcycles and motor vehicles.

### CROSS-REFERENCE TO RELATED PRIOR APPLICATION

This application claims priority pursuant to 35 USC 119 of Canadian application no. 2,935,115 filed Jul. 4, 2016 in the Canadian Intellectual Property Office, which application is incorporated herein by reference.

### BACKGROUND OF THE INVENTION

Interruption of electrical power is a common occurrence in inclement weather such as hurricanes, ice storms and severe rain storms. During such weather, outages of electrical power can cause severe consequences such as disruptions in surgical operations in hospitals, disruptions in flights into and out of airports and disruptions on highways. To obviate such consequences, alternate sources of electrical power are customarily provided. Commonly, those sources are batteries or gasoline or propane driven generators.

Alternate sources of electrical power are frequently not available in situations in which a power outage does not result in severe consequences,. Such is usually the case in residential areas, office buildings and factories. I have found however, that electrical power can be restored at such places, at least partially, by a rack activated by devices commonly found in such places such as bicycles, automobiles, trucks and recreational vehicles such as motorcycles and All Terrain Vehicles (ATV's). No external source of electrical power is necessary to activate my rack and, once activated, the rack produces electrical power suitable for restoring some or all of the power required during the outage. The rack is the subject matter of the subject invention.

The rack of my invention may be used in a residential area as well as a store, a factory or other permanent location where there is a need for electrical power. The rack may also be used in places which are not permanent such as the site of an accident on a highway and the site of a forest fire. In the latter cases the rack may be mounted on a trailer and towed by means of an automobile or truck to the site and once there, the towing vehicle may be used to activate the rack. Where there is no road, such as in the bush or on farm land, the rack may be towed by an ATV and activated by the ATV at the site.

### SUMMARY OF THE INVENTION

Briefly, the rack of my invention comprises: a frame; a pair of parallel spaced apart rollers; and a generator in communication with the rollers for converting the energy of rotation of the rollers into electrical energy, the frame having bearings in which the rollers rotate, the frame being adapted to support a vehicle having a driving wheel through which a source of power of rotation operates, the frame being arranged and constructed to support the vehicle so that the driving wheel is positioned between the rollers and when rotating causes the rollers to rotate while the vehicle remains stationary.

### DESCRIPTION OF THE DRAWINGS

The rack of my invention is described in detail with reference to the accompanying drawings in which:

FIG. 1 is perspective view of the rack of the invention mounted on a conventional trailer shown in broken lines;

FIG. 2 is another perspective view of the rack in conjunction with an array of batteries and a pair of wheels, one of which activates the rack while the other remains immobile, the wheels being shown in broken lines;

FIG. 3 is an exploded perspective view of a portion of a side wall of the rack in conjunction With a number of pulleys;

FIG. 4 is a perspective view of a portion of a side wall of the rack;

FIG. 5 is a perspective view of a portion of a side wall of the rack in conjunction with a pulley, drive belt and a generator;

FIG. 6 is another view of the side wall, pulley, drive belt and a generator located on the side opposite that illustrated in FIG. 5;

FIG. 7 is a side view of the rack and a wheel which activates the rack;

FIG. 8 is the same as FIG. 7 except that a smaller sized wheel activates the rack;

FIG. 9(a) is an elevation of the rack and a scooter seated on the rack;

FIG. 9(b) is an elevation of the rack and a bicycle seated on the rack;

FIG. 10 is an elevation of the rack and an ATV which activates the rack;

FIG. 11 is an elevation of the rack and a six-wheeled military vehicle;

FIG. 12 is an elevation of the rack and a motorcycle strapped to the rack; and

FIG. 13 is a plan view of the rack.

Like reference characters refer to like parts throughout the description of the drawings.

### DESCRIPTION OF PREFERRED EMBODIMENTS OF THE INVENTION

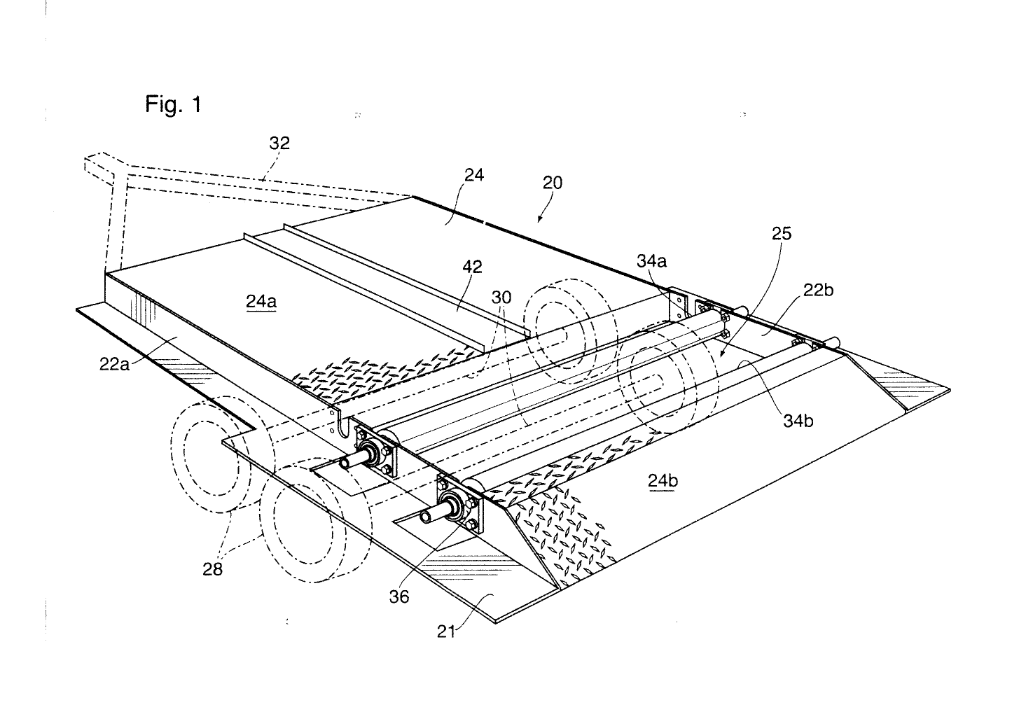

With reference to FIG. 1, the power generating rack of the invention comprises a frame, generally 20 having a lower wall 21, spaced apart side walls 22a,b and an upper wall 24. The rack is seated on a conventional trailer having wheels 28 rotatable about transversely extending axles 30. A trailer hitch 32 is provided at the front end of the trailer for attachment to a towing vehicle.

The upper wall of the frame consists of two surfaces, a forward surface 24a which is flat when the rack is in use. Horizontal and a rear surface 24b are sloped downward above the rear end of the trailer. Between the two surfaces is an opening 25 below which a pair of rollers 24a, 25b is located.

The rear surface 24b forms a ramp for a vehicle which facilitates the movement of the vehicle onto and off the rack.

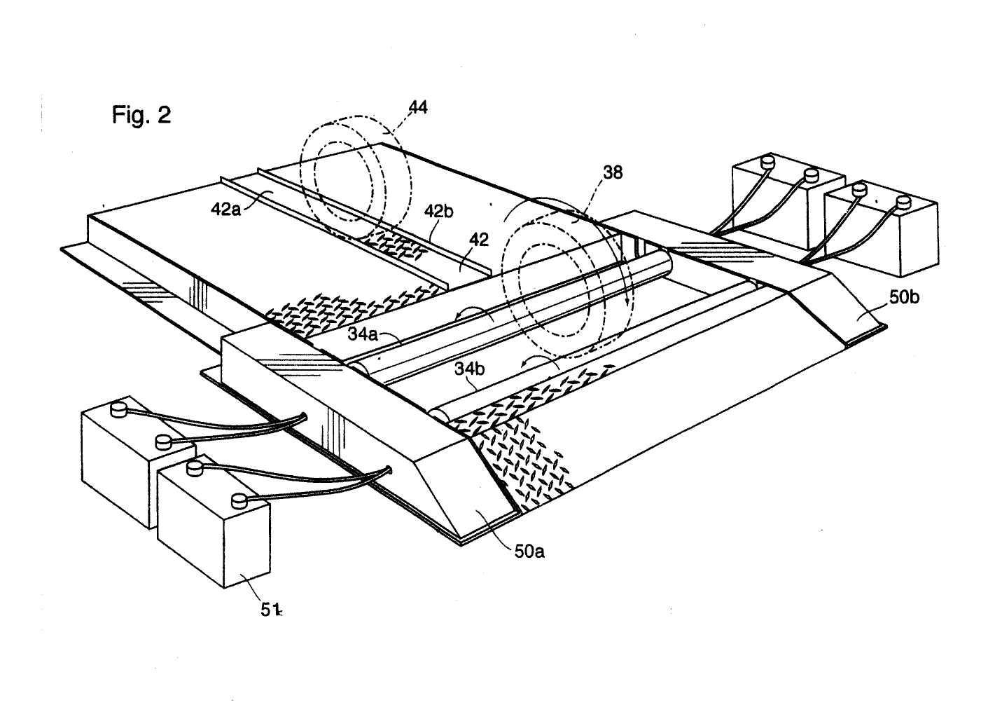

With reference to FIGS. 1 and 2 rollers 34a,b are mounted for rotation in bearings 36 in the side walls of the frame. The rollers are parallel to one another and are caused to rotate by driving wheels, (not shown in FIG. 1) and numbered 38 in FIG. 2.

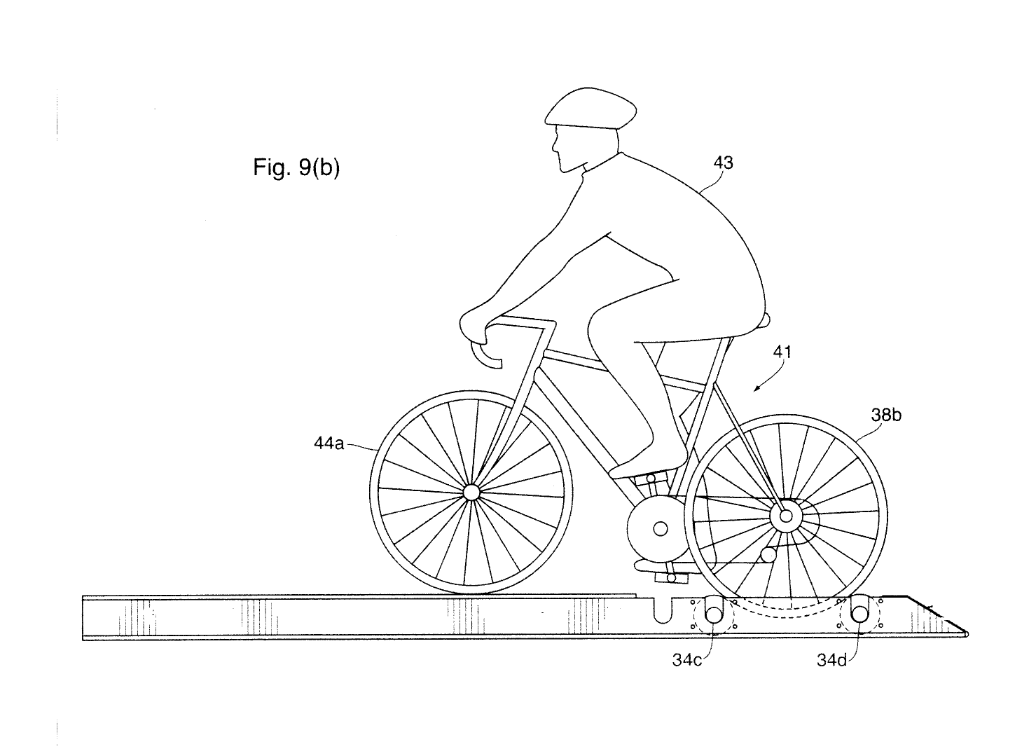

In FIG. 9a, the driving wheel is the rear wheel 38a of a two-wheeled scooter, generally 40. In FIG. 9b, the driving wheel is the rear wheel 38b of a bicycle, generally 41. In both vehicles the driving wheel is seated on a pair of adjacent rollers located in opening 25 in the frame. In FIG. 9a, driving wheel 38a is seated on rollers 34a,b and in FIG. 9b the driving wheel 38b is seated on rollers 34c,d. As illustrated, the driving wheels are located between the two rollers but are both in contact with both of the rollers so that rotation of the driving wheels cause both rollers in each vehicle to rotate.

The driving wheel in the scooter is driven by a source of power in the form of an internal combustion engine or a battery generally 39a while the source of power for activating the driving wheel of the bicycle is the operator 43 of the bicycle. In both vehicles, the source of power is external to the rollers and to the rack.

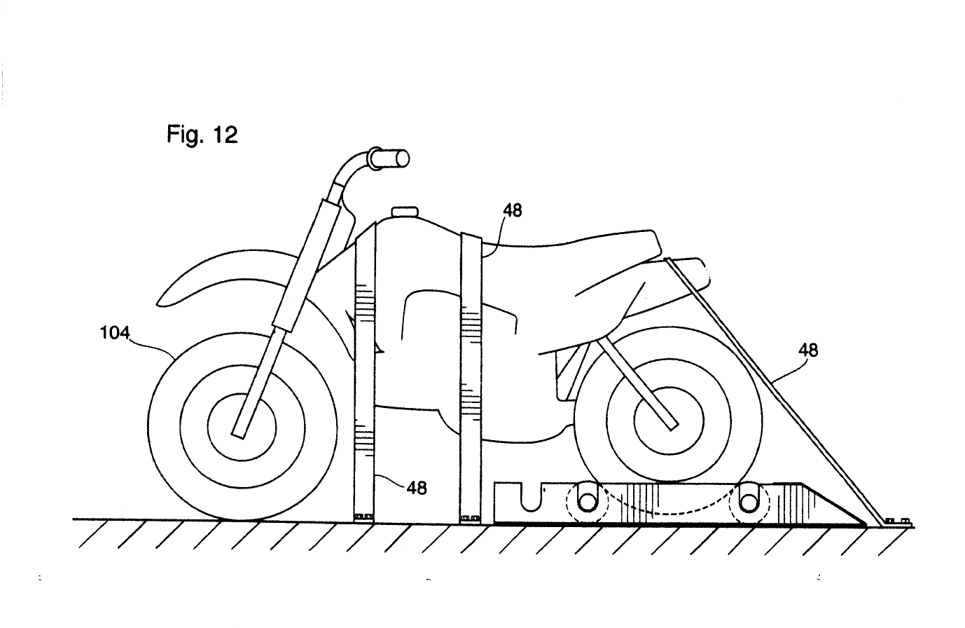

Witt reference to FIG. 1, a track 42 is located on the upper surface 24a of the frame forward of the rollers for supporting the non-driving forward wheel 44 of the scooter and the forward wheel of the bicycle. The track extends parallel to the side walls of the frame and in the direction of movement of the vehicle when travelling forward. However, when the scooter, bicycle or other two-wheeled vehicle is on the upper wall of the frame the vehicle remains at a standstill since its driving wheel causes the rollers to rotate but does not cause the vehicle to move forward. With reference to FIG. 2, the track consists of a lower wall 42a and upstanding side walls 42b. The side walls function to confine the non-driving wheel 44 of the vehicle within the track so that the driving wheel 38 remains in the position on the rollers to transmit all of its energy to the rollers. The non-driving wheel can be immobilized by other means such as by straps 48 as illustrated in FIG. 12.

The rollers as they rotate activate one or two conventional generators within housings 50a,b at the sides of the frame and the generators in turn generate electric power for charging batteries 51.

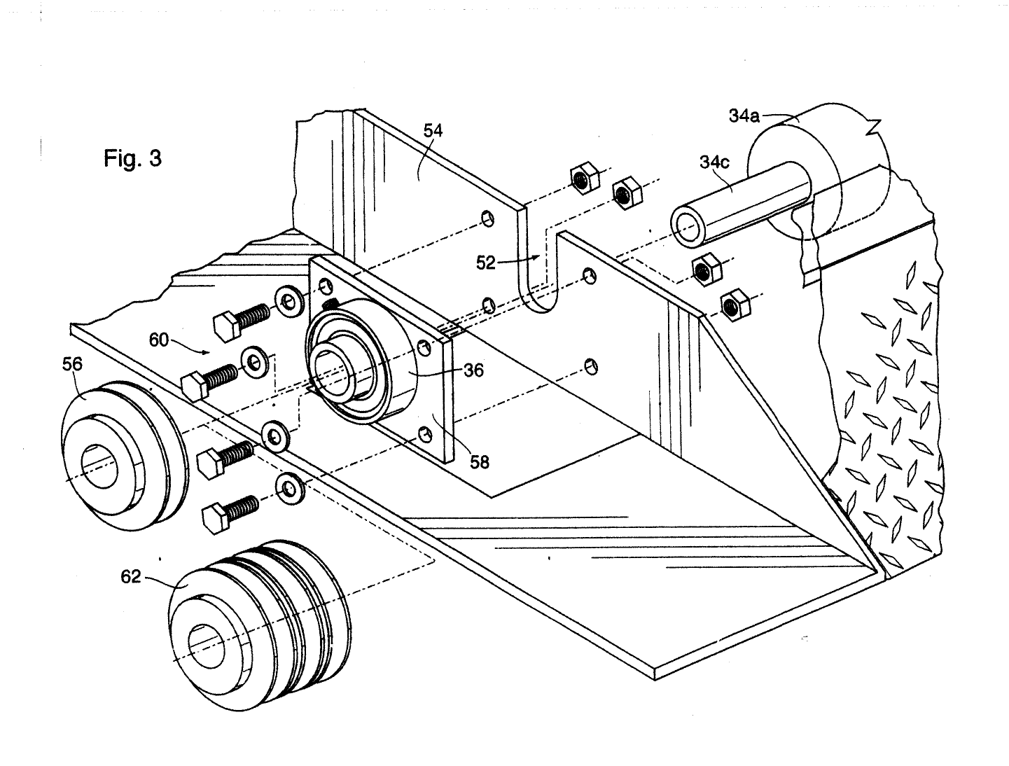

With reference to FIG. 3, the axle 34c of one or other of rollers 34a,b extends through a slot, generally 52 in side wall 54 of the frame and through bearing 36 and to pulley 56 to which it is connected. The bearing is attached to a plate 58 and the plate is attached to the side wall by nuts and bolts generally 60. Pulley 56 may be replaced by the array of pulleys 62 should the pulleys activate more than one generator (not illustrated).

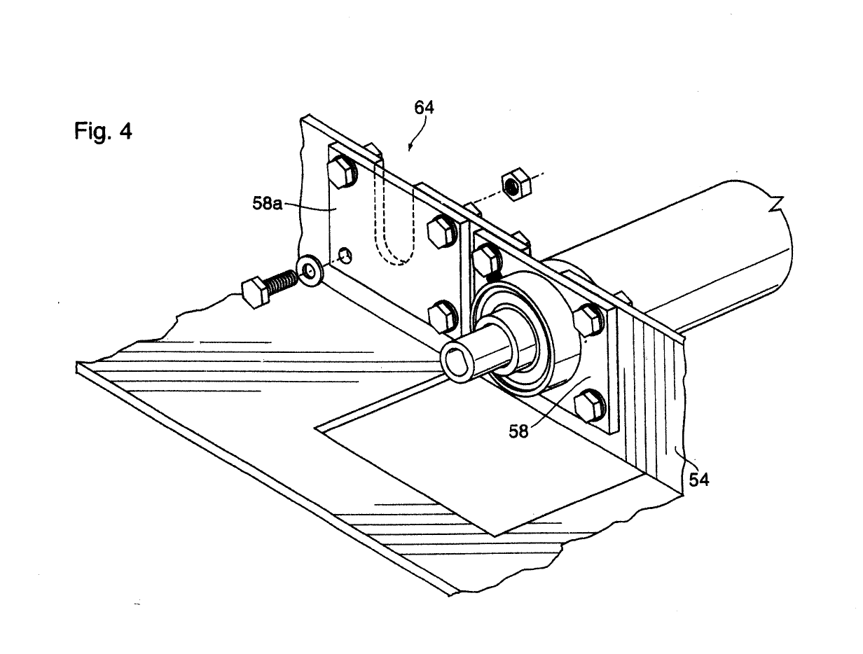

The location of the plate on the side wall 54 can be altered by unbolting it from the location illustrated and by bolting it against the side wall at another location 64 where there is a slot in the frame as illustrated in FIG. 4. The bearing remains attached to the plate no matter where the plate is located on the frame. The bearing is not illustrated at the new location. Rather there is a plate 58a which lacks a bearing but is attached to the side wall 54 in the same way as plate 58. Plate 58a is provided to strengthen the side wall since the wall is weakened by a slot.

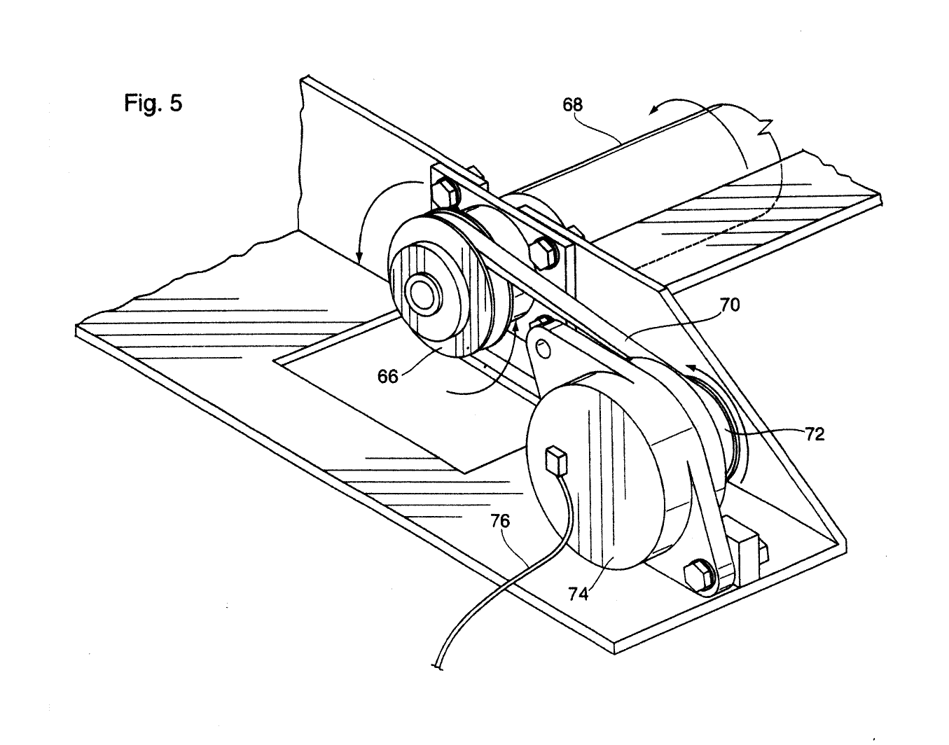

In FIG. 5, a pulley 66 is attached to the end of the axle of roller 68. The pulley drives a belt 70 which is wound around a second pulley 72 which, in turn, drives a conventional generator 74. Generated electrical power flows to a battery (not illustrated) through wire 76.

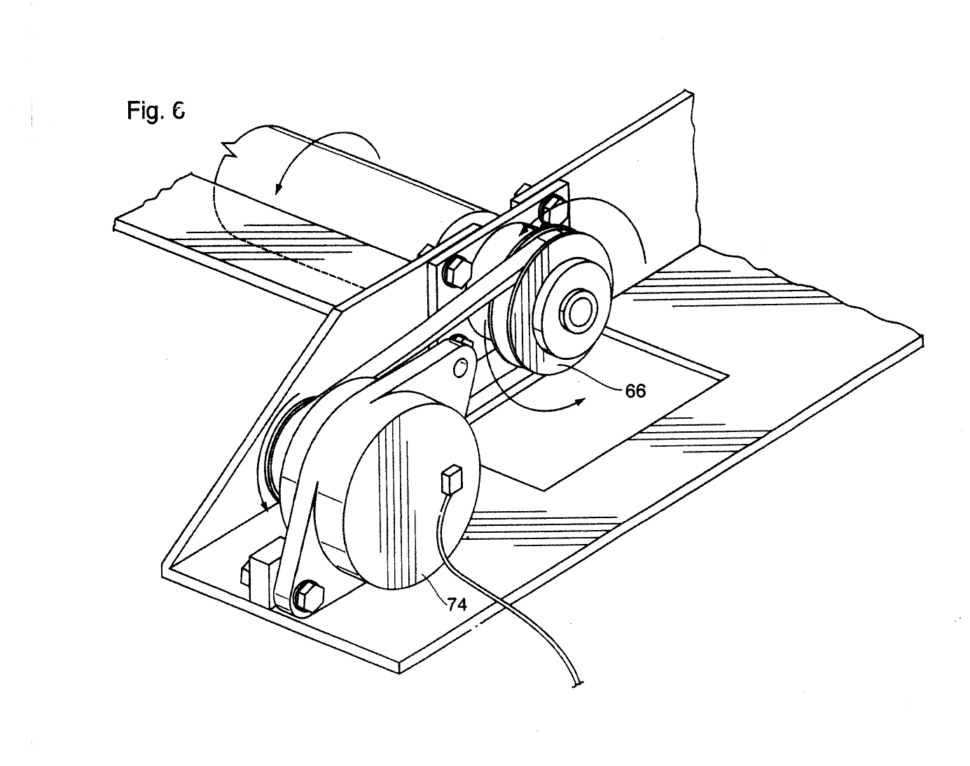

Generator 74 may be on either side of pulley 66. In FIG. 5 it is to the right of the pulley and in FIG. 6 it is to the left.

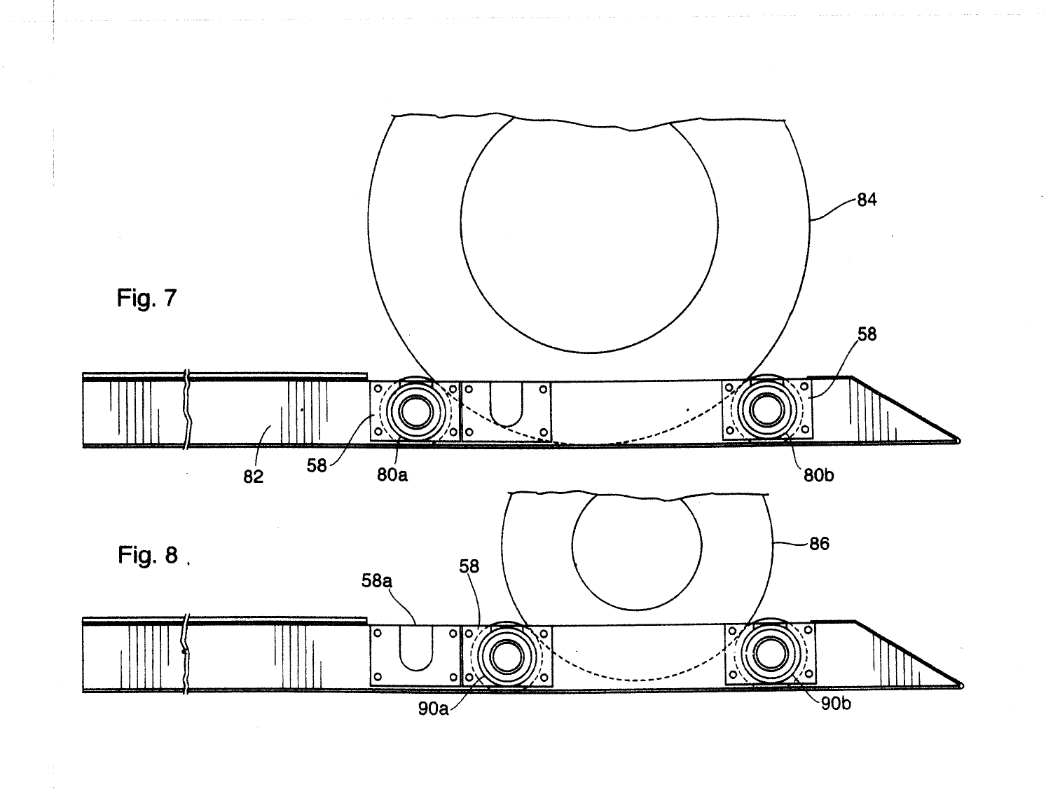

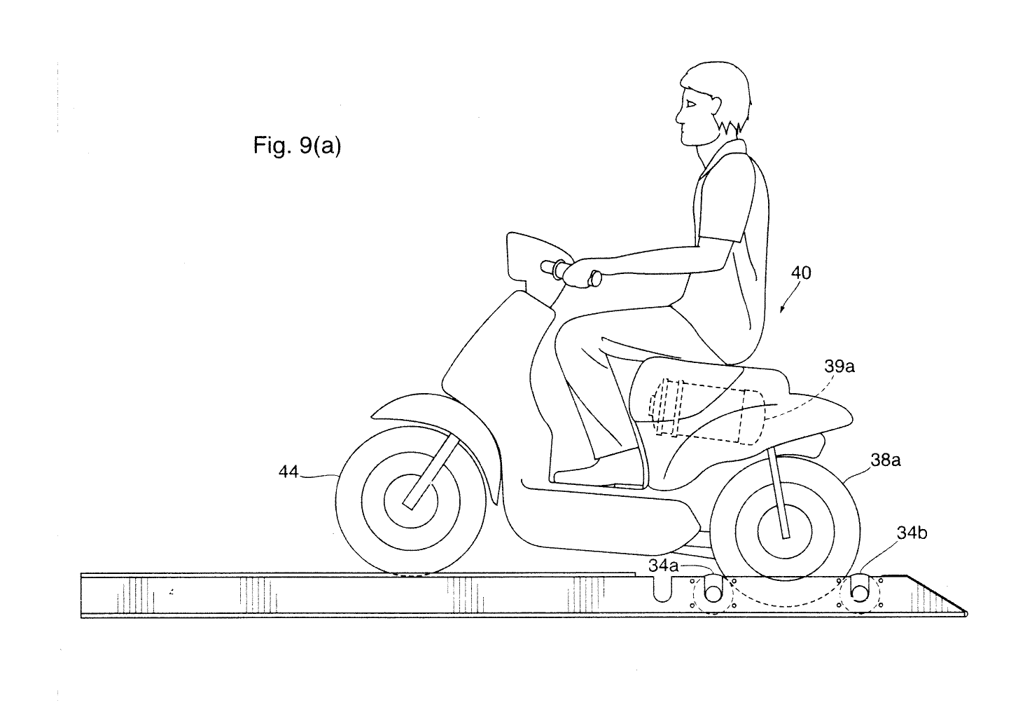

With reference to FIGS. 7-9a,b, the spacing between the rollers can be adjusted to best support a wheel which rests on them as discussed above with reference to FIG. 4. In FIG. 7, bearings 80a,b are located on side wall 82 such that the rollers support a relatively large wheel 84 such as a driving wheel of a tractor. In FIG. 8 the rollers support a smaller wheel 86 such as the driving wheel of a scooter as illustrated in FIG. 9a. The distance between bearings 90a,b in FIG. 8 is less than that of bearings 80a,b in FIG. 7.

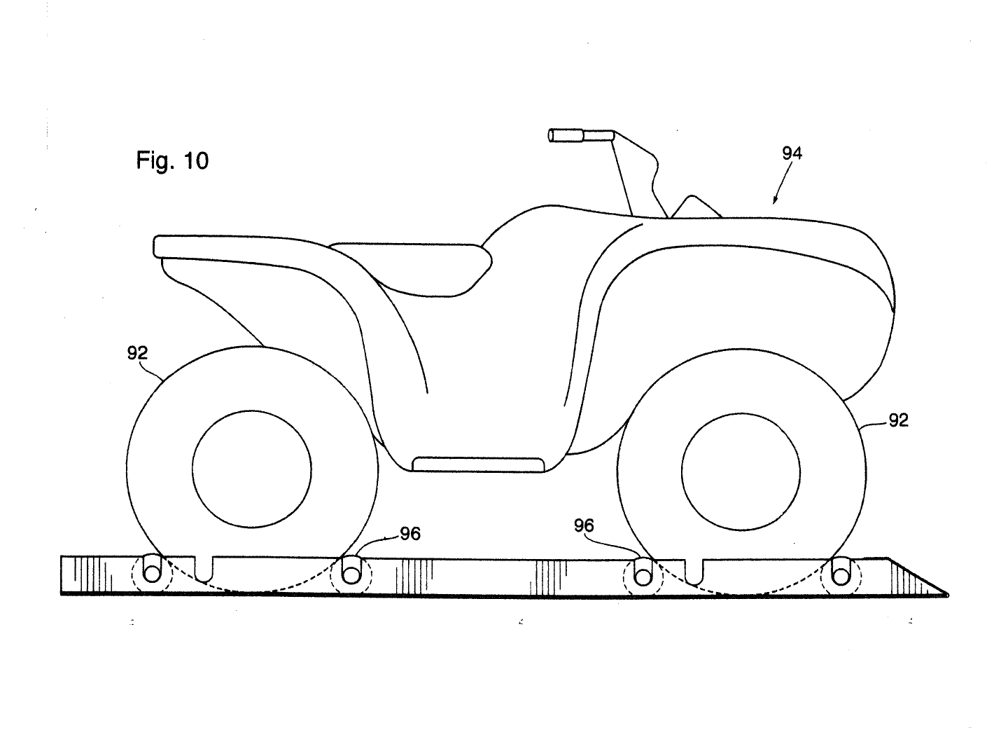

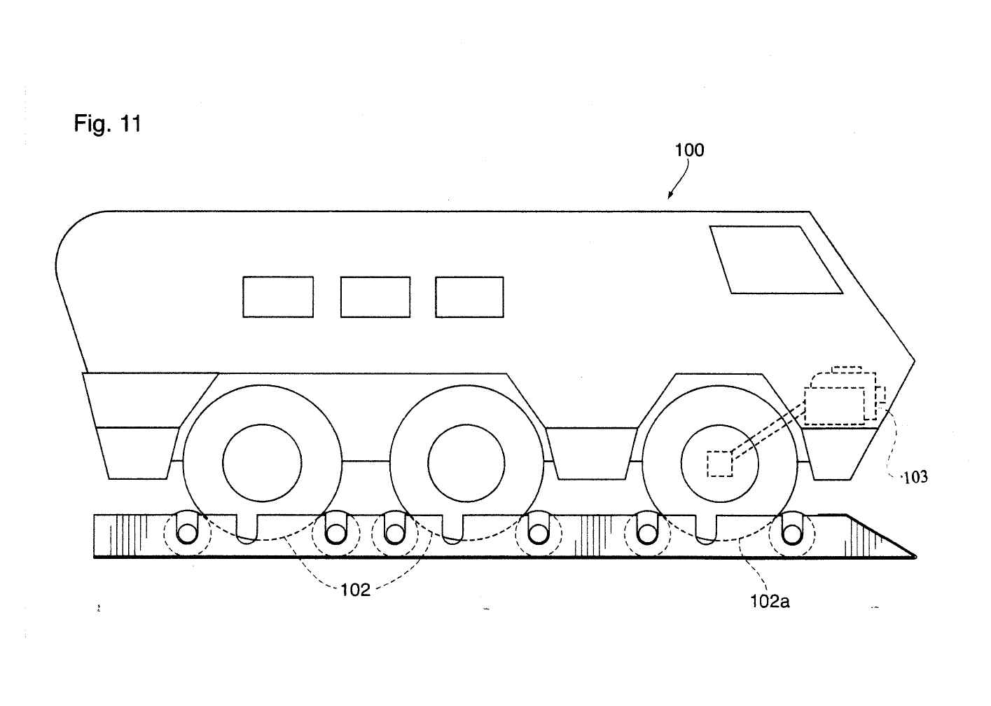

In FIG. 10, all the wheels 92 of an ATV, generally 94 are driving wheels and all rest on rollers 96 so that the vehicle activates at least two generators (not illustrated) one of which is activated by the front wheels and the other activated by the rear wheels. In FIG. 11 the illustrated vehicle 100 is a military vehicle in which all the driving wheels 102 are driving and the wheels activate at least three generators. The source of power for the driving wheels is a conventional internal combustion engine 103 which is shown as activating only the front driving wheel 102a in the drawing but which may activate the remaining driving wheels. It will be observed in FIGS. 10 and 11 that the position of the rollers is adjusted so that all the wheels drive rollers which activate generators.

In FIG. 12 the illustrated motorcycle is immobilized by means of straps 48 so that the front non-driving wheel 104 rests on the forward surface of the upper wall of the frame. Since the wheel is anchored to the surface, obviously there is no necessity for a track.

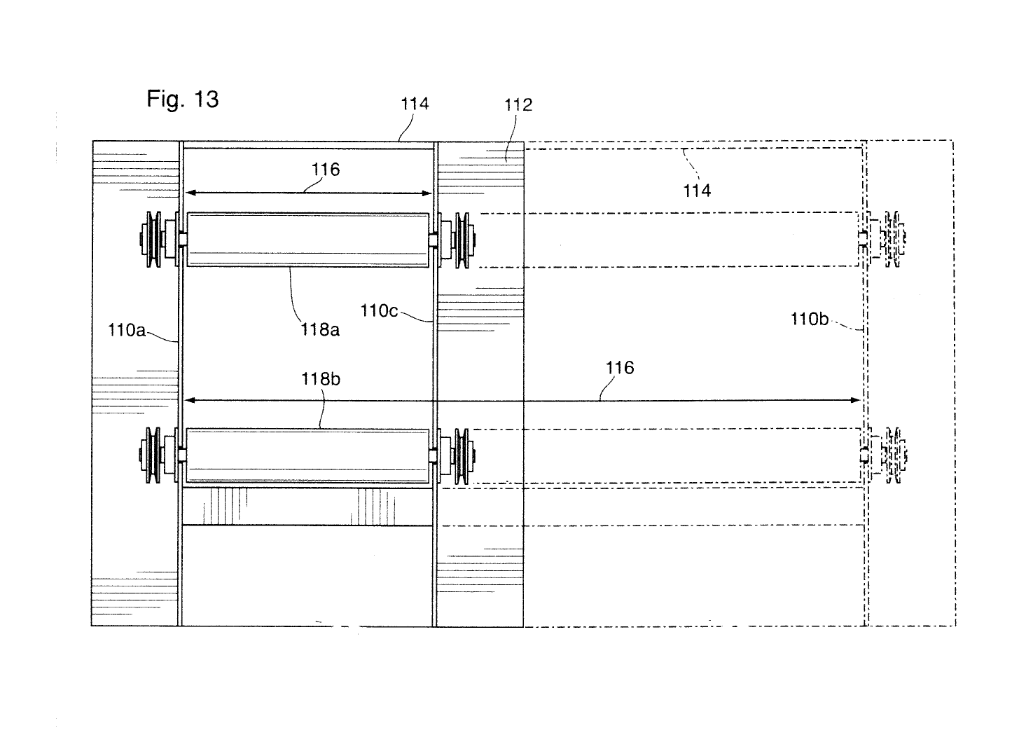

In FIG. 13, the frame is provided with side walls 110a,b such as side walls 22a,b in FIG. 1 and an intermediate sliding wall 110c which is parallel to side walls 110a,b and which extends upwardly from a carriage 112. The carriage is mounted for sliding on tracks (one illustrated and numbered 114) and the track extends normal to the side walls of the frame in the direction of arrows 116 between the side walls 110a,b.

Side wall 110a and sliding wall 110c are provided with an array of bearings in which the ends of the rollers rotate. The bearings in the two walls face one another. The bearings in side wall 110a are referred to below as first bearings and while not shown in FIG. 13 are the same as those in FIG. 1 as are the bearings in the sliding wall 110c

The position of the sliding wall 110c can be adjusted to anywhere between two positions, one shown in solid lines and the other shown in broken lines in order to support rollers 118a,b of varying lengths, the better to accommodate vehicles of various sizes and shapes.

It will be understood, of course, that modifications can made in the structure of the subject power generating rack without departing from the scope and purview of the invention as defined in the appended claims.

I claim:

1. A power generating rack for converting the energy of rotation of a roller into electrical energy, said rack including: a frame; a pair of parallel driven rollers adjacent to one another and mounted for rotation on said frame, and a generator for converting the energy of rotation of said driven rollers into electrical energy, said frame being arranged and constructed to support a vehicle having a plurality of wheels at least one of which defining a driving wheel and being adapted to rotate by means of a source of power external from said rack, said frame further arranged and constructed to support said vehicle in a stationary position on said rack such that said driving wheel is in contact with and between said driven rollers where said driving wheel is in position to cause said driven rollers to rotate while the remaining said wheels remain immobile, said generator being in communication with said driven rollers for converting the energy of rotation of said rollers into electrical energy.

2. The rack of claim 1 wherein said frame is mounted on wheels for mobility.

3. The rack of claim 1 wherein said rollers are mounted in bearings, the position of which is adjustable such that the position of said rollers is adjustable on said frame.

4. The rack of claim 1 wherein the distance separating said rollers is adjustable.

5. The rack of claim 1 further including a carriage slidably mounted to said frame, a plurality of first bearings mounted to said frame, a plurality of second bearings mounted to said carriage, each said roller having a pair of opposite ends, one of which being mounted for rotation in one said first bearing and the other said end of each said roller being mounted in one said second bearing, the distance between said first bearings and said second bearings being adjustable as said carriage slides to accommodate rollers of varying lengths.

6. A power-generating rack for converting the energy of rotation of rollers into electrical energy, said rack including: a frame; a plurality of parallel spaced apart rollers mounted for rotation on said frame and consisting of a plurality of driven said rollers and a plurality of non-driven said rollers, said frame and said rollers being arranged and constructed to support a vehicle having a plurality of wheels consisting of driving wheels each of which is adapted to be caused to rotate by a source of power external from said rack, and non-driving wheels adapted to rotate without use of a source of power, said frame and said rollers further being arranged and constructed to support said vehicle in a stationary position on said rollers such that said driving wheels are in contact with and between a pair of adjacent said driven rollers while said non-driving wheels are in contact with said non-driven rollers; and a generator in communication with said driven rollers for converting the energy of rotation of said rollers into electrical energy.

7. The rack of claim 6 wherein said frame is mounted on wheels for mobility.

8. The rack of claim 6 wherein said rollers are mounted in bearings, the position of which is adjustable such that the position of said rollers is adjustable on said frame.

9. The rack of claim 6 wherein the distance separating said rollers is adjustable.

10. The rack of claim 6 further including a carriage slidably mounted to said frame, a plurality of first bearings mounted to said frame, a plurality of second bearings mounted to said carriage, each said roller having a pair of opposite ends, one of which being mounted for rotation [symbol]
